(19) United States
(12) Patent Application Publication
(10) Pub. No.: US 2004/0144026 A1
(43) Pub. Date: Jul. 29, 2004

(54) Aerated plant pot

(76) Inventor: Jianhua Fan, Nashville, TN (US)

Correspondence Address: Jianhua Fan, 5800 Maudina Ave. C-2, Nashville, TN, 37209, US

(21) Appl. No.: 10/716,054

(22) Filed: Nov. 18, 2003

Related U.S. Application Data
(60) Provisional application No. 60/432,752, filed on Dec. 12, 2002.

(51) Int. Cl. A01G 9/02

(52) U.S. Cl. 47/65.5

(57) ABSTRACT

Aerated plant pots having a side wall and a bottom wall, at least one hole disposed on the bottom wall of the pot, at least one aeration tunnel extending upwardly from bottom wall of the pot, the at least one aeration tunnel having side wall(s) or/and a top wall, a plurality of holes/slots disposed on the wall(s) of the aeration tunnel, the shape of the aeration tunnel may be vary and may extending to side wall of the pot and without end wall, at least one air chennel may be applied for more air flows in/out the aeration tunnel. The aeration tunnel may be used in self watering pot apparatus. The aerated plant pot further comprising a tray while the aerated plant pot is used inside of building.

This patent application claims the benefit of Provisional patent application, U.S. serial No. 60/432,752, filed on Dec. 12, 2002, entitled “AERATED PLANT POT”, by Jianhua Fan; the subject matter of which are hereby incorporated by reference.

### BACKGROUND OF THE INVENTION

1. Field of the Invention

The present invention relates to plant pot, more particularly to aerated plant pot. The aerated plant pot provids more air for vital plant roots system.

2. Description of the Prior Art

Most of the existing plant pot having holes or slots disposed on the bottom wall of the pot, some of them also having a cross channel formed from the bottom wall of the pot, for air flowing under the pot bottom. In general it is difficult to let air flows in and out of the bottom of the pot while water accumulated on lower level of the pot, and roots will be damaged by water due to lack of air. Plant roots more like to grow inner circle on the bottom of the pot, do not like to grow in the center of soil due to lack of air therein. Some self watering pots provided more air circle under the pot bottom, but the center of the soil still lack of air. So that plant roots still grow inner circle of the pot bottom, do not like to grow into center of the soil too. Some experts put toxic metal on lower inside wall of the pot to stop roots runing around inner pot, and hope that roots will change thire growing directions, then grow into center of the soil, but roots still do not like to grow into center of the soil. The problem is the same: lack of air in center of the soil in the pot.

It can be seen then that there is a need for an aerated plant pot to stop roots running around inner circle of the pot, and provid more air in soil for a vital roots system for the plant.

It is with respect to these and other considerations that the present invention has been made.

### SUMMARY OF THE INVENTION

The present invention relates to a plant pot, more particularly to aerated plant pot.

The present invention discloses aerated plant pot apparatus. The aerated plant pots are capable of providing more air in center of the soil in the pot for vital plant roots system, enhance roots growing condition in soil, reduces roots running around inner circle in the pot.

In one embodiment of the present invention, an aerated plant pot apparatus includes: a pot, the pot having a side wall and a bottom wall, at least one hole disposed on the bottom wall, at least one aeration tunnel, in shape of circular (the aeration tunnel can be others shape such as rectangle, cone, prism and so on) extending upwardly from the bottom wall of the pot, the at least one aeration tunnel having a side wall and a top wall (it can be side wall only, such as cone or prisms shape), a plurality of holes/or slots disposed on the side wall and the top wall, air gets into center of soil through the holes/or slots on the walls of the aeration tunnel. More than one rectangle shapes may be cross connected into one piece.

Still in one embodiment of the present invention, the rectangle/prism shapes may be extending to the side wall of the pot and without end tunnel walls, so that air flow into tunnel more easily than others shapes. The different shape provids different air flowing rates for different plant needs.

Furthermore in one embodiment of the present invention, the aeration tunnel may be used in self watering plant pot in the same way as discripted above.

These and various other advantages and features of novelty which characterize the invention are particularly pointed out in the claims annexed hereto and form a part hereof. However, for a better understanding of the invention, its advantages, and the objects obtained by its use, reference should be made to the drawings which form a further part hereof, and to the accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a partial perspective view of an aerated plant pot with one circular shape aeration tunnel, from bottom, of one embodiment in accordance with the principles of the present invention.

FIG. 2 is a partial perspective view of an aerated plant pot with four circular shape aeration tunnels, from top, of one embodiment in accordance with the principles of the present invention.

FIG. 3 is a perspective view of an aerated plant pot with a rectangle shape aeration tunnel, from top, of one embodiment in accordance with the principles of the present invention.

FIG. 4 is a perspective view of an aerated plant pot with two rectangle shape aeration tunnels which crossing connected, from top, of one embodiment in accordance with the principles of the present invention.

FIG. 5 is a perspective view of an aerated plant pot with two rectangle shape aeration tunnels which crossing connected, and extending to the side wall of the plant pot, from top, of one embodiments the present invention.

FIGS. 6 and 7 are the perspective view from bottom of self watering plant pot of one embodiment in accordance with the principles of the present invention.

### DETAILED DESCRIPTION OF THE PREFERRED EMBODIMENT

In the following description of the exemplary embodiment, reference is made to the accompanying drawings which form a part hereof, and in which it is shown by way of illustration the specific embodiment in which the invention may be practiced. It is to be understood that other embodiments may be utilized as structural changes may be made without departing from the scope of the present invention.

The present invention provides an aerated plant pot apparatus. The aerated plant pot apparatus in accordance with the principles of the present invention is capable of providing more air circle in soil to avoid root rotten, keep plant health and longer.

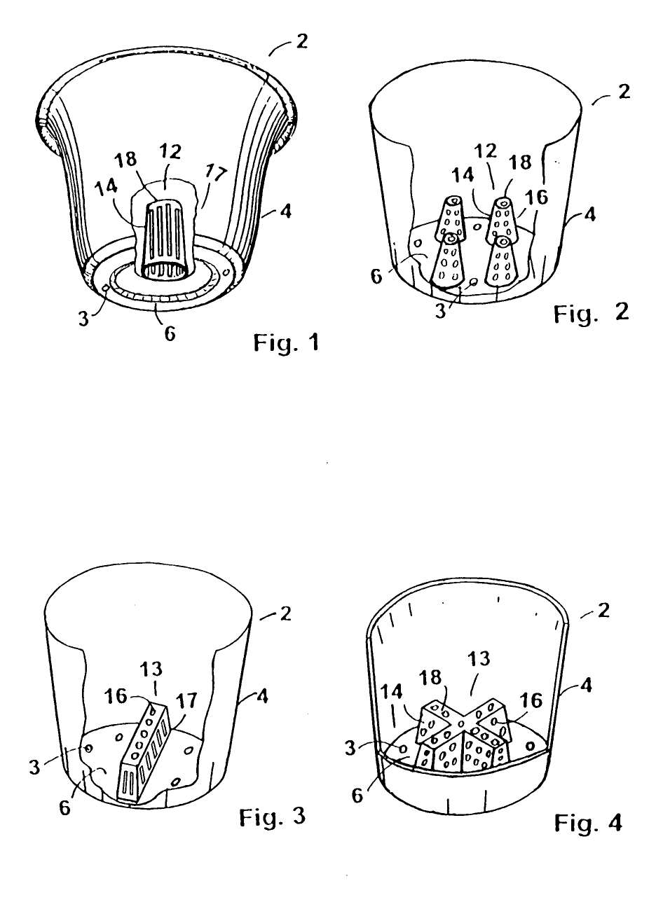

In FIG. 1, there is generally illustrated by reference numeral 2 a first embodiment of an aerated plant pot apparatus in accordance with the principles of the present invention. The aerated plant pot apparatus 2 includes: a side wall 4, a bottom wall 6, a plurality of holes 3 disposed on the bottom wall 6, and at least one aeration tunnel 12 extending upwardly from the bottom wall 6, the aeration tunnel 12 having a side wall 14 and a top wall 18, a plurality of slots 17 disposed on the side wall 14 and the top wall 18. The shape of the aeration tunnel can be vary, such as rectangle, cone, prism and so on. Some plant needs more air in soil, so that, at least one air chennel (in FIG. 7, numeral 8) may be used in this apparatus (most pot having such chennel). Also, holes may be instead of the slots on the side wall and the top wall of the aeration tunnel (in FIG. 2, numeral 16).

In FIG. 1, the at least one aeration tunnel 12 may have no top wall 18 while it is in the others shape, the height of the aeration tunnel may be vary, it is depends on the size of the pot.

In FIG. 1, a tray (not show) may be used while the aerated plant pot is used inside of buildings.

In FIG. 2, a plurality of aeration tunnels 12 disposed on the bottom wall 6 of a plant pot 2, and a plurlity of holes 16 disposed on the side wall 14 and top wall 18.

In FIG. 3, a rectangle shape aeration tunnel 13 extending upwardly from the bottom wall 6 of the plant pot 2, a plurality of slots and/or holes disposed on the walls of the aeration tunnel 13.

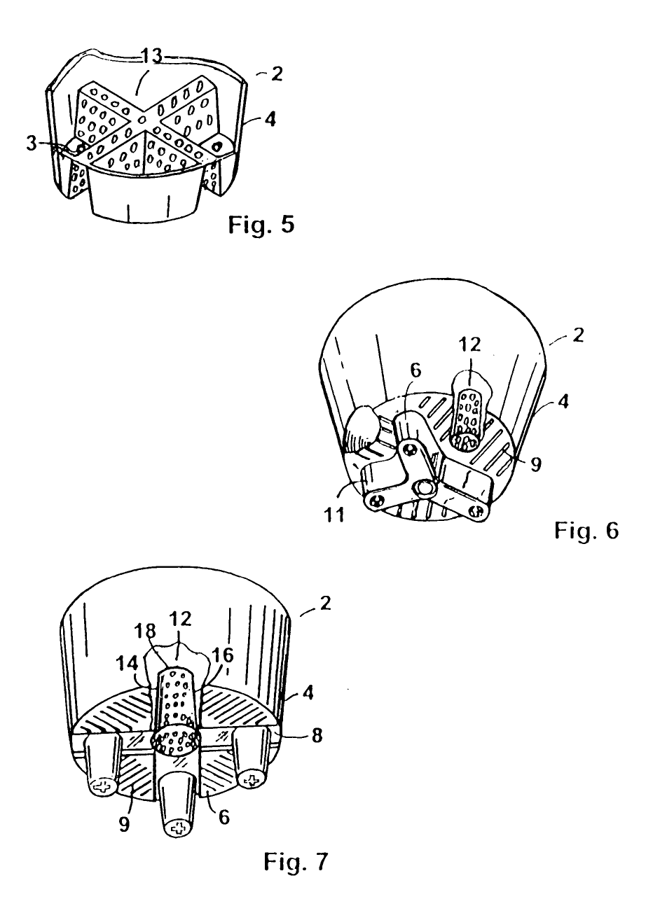

In FIG. 4, two rectangles 13 cross connected. In FIG. 5, the crossed tunnels 13 extending to the side wall 4 of the plant pot 2 and without end walls. So that, air more easy to flow in tunnel 13.

FIGS. 6 and 7 are two self watering pot apparatus (a tray does not show in the Figures), the aeration tunnel can be applied therein too.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. An aerated plant pot apparatus comprising:
a plant pot, the plant pot having a side wall and a bottom wall, a plurality of holes/slots disposed on the bottom wall; and
at least one aeration tunnel extending upwardly from the bottom wall of the plant pot, the aeration tunnel having at least one side wall, a top wall, a plurality of slots/holes disposed on the side wall and the top wall.

2. The aerated plant pot apparatus of claim 1, wherein the at least one aeration tunnel is in cone shape.

3. The aerated plant pot apparatus of claim 1, wherein the at least one aeration tunnel is in prism shape.

4. The aerated plant pot apparatus of claim 1, wherein the at least one aeration tunnel is in rectangle shape.

5. The aerated plant pot apparatus of claim 3, wherein two aeration tunnels cross connected.

6. The aerated plant pot apparatus of claim 5, wherein the aeration tunnels extending to the side wall of the plant pot and without end walls.

7. The aerated plant pot apparatus of claim 4, wherein two rectangle aeration tunnels cross connected.

8. The aerated plant pot apparatus of claim 7, wherein the aeration tunnels extending to the side wall of the plant pot and without end walls.

9. The aerated plant pot apparatus of claim 1, further comprising at least one air chennel formed on the bottom wall of the pot.

10. The aerated plant pot apparatus of claim 1, further comprising a tray for reserving drain water while the pot is used inside of buildings.

11. An aerated self watering plant pot apparatus, comprising:
a pot, the pot having a side wall and a bottom wall, a plurality of holes/slots disposed on the bottom wall, at least one leg extending downwardly from the bottom wall of the pot; and
a tray, the tray having a side wall and a bottom wall; and
at least one aeration tunnel extending upwardly from bottom wall of the pot, the aeration tunnel having a side wall, a plurality of holes/or slots disposed on the wall, the shape of the aeration tunnel can be vary.
